(19) United States
(12) Patent Application Publication
(10) Pub. No.: US 2013/0049376 A1
(43) Pub. Date: Feb. 28, 2013

(54) Door lock for a dishwashing machine

(71) Applicants: Albert Dirnberger, Neunburg vorm Wald (DE); Georg Spiessl, Altendorf (DE); Peter Nitsche, Beilngries (DE); Markus Lang, Neunburg vorm Wald (DE)

(72) Inventors: Albert Dirnberger, Neunburg vorm Wald (DE); Georg Spiessl, Altendorf (DE); Peter Nitsche, Beilngries (DE); Markus Lang, Neunburg vorm Wald (DE)

(73) Assignee: EMZ-HANAUER GMBH & CO. KGAA, Nabburg (DE)

(21) Appl. No.: 13/397,755

(22) Filed: Feb. 16, 2012

(30) Foreign Application Priority Data
Feb. 18, 2011 (DE) 10 2011 011 662.1

(51) Int. Cl. E05C 9/04

(52) U.S. Cl. 292/17

(57) ABSTRACT

A door lock for a dishwashing machine includes a lock housing, a pair of closing arms being held in and projecting from the lock housing and having free arm portions projecting from the lock housing that are deflectable relative to one another from a relative normal position in a first deflection direction counter to the action of a resetting spring arrangement, and a closing mouth, into which the free arm portions engage during closing of the door, having deflection surfaces encountered by the free arm portions during engagement into the closing mouth and which bring about a relative deflection of the free arm portions counter to the resetting action of the resetting spring arrangement, where the free arm portions during further engagement is move past the deflection surfaces and in so doing experience an at least partial resetting in the direction of their relative normal position.

### BACKGROUND OF THE INVENTION

1. Field of the Invention

The present invention relates generally to a door lock for a dishwashing machine or the like as well as to a dishwashing machine having such a door lock.

2. Description of the Prior Art

With the aid of such a door lock, the door of the dishwashing machine may be kept closed for example during a washing operation and, when required, re-opened, for example after the washing operation.

Door locks for dishwashing machines are known, which are fitted in the upper part of the appliance housing and engage with a closing lug down into a closing trough of the door. This is used to keep the door closed during the washing operation, even if an attempt is made to open it. Without releasing the door lock the door may be opened only with a considerable expenditure of force. Improper opening of the door by applying a high expenditure of force may lead to damage of the door lock. Such a door lock is known for example from DE 102006037494 of the applicant. These known door locks are of a complex mechanical design.

With the aid of such door locks, the door is to be reliably kept closed during the washing operation since opening during the washing operation can lead to injuries, such as scalding, as a result of hot steam escaping from the door aperture.

### SUMMARY OF THE INVENTION

Dishwashing machines, for which the presently considered door lock is suitable, comprise a housing with a door aperture that is closable by means of a door fitted movably on the dishwashing machine (appliance housing). The door lock may be fitted in the appliance housing or in the door. It is also possible for elements of the door lock to be disposed in the appliance housing and other elements in the door.

It is an object of the present invention to provide a simply designed door lock for a dishwashing machine and a dishwashing machine having such a door lock, by means of which the door of the dishwashing machine is reliably kept closed during the washing operation.

This object is achieved by the subject matter of the independent claims. Advantageous embodiments emerge from the dependent claims.

The door lock according to the invention for a dishwashing machine comprises a lock housing and a pair of closing arms, which are held in and project from the lock housing. Free arm portions of the closing arms that project from the lock housing are deflectable relative to one another from a relative normal position in a relative first deflection direction counter to the action of a resetting spring arrangement. The door lock further comprises a closing mouth, into which the free arm portions of the closing arms engage during closing of the door of the dishwashing machine. Disposed on the closing mouth are deflection surfaces, which the free arm portions encounter during engagement into the closing mouth and which bring about a relative deflection of the free arm portions counter to the resetting action of the resetting spring arrangement. The free arm portions upon further engagement move past the deflection surfaces and in so doing experience an at least partial resetting in the direction of their relative normal position.

The lock housing may be disposed together with the closing arms for example on an appliance housing of the dishwashing machine, while the closing mouth may be disposed on the door of the dishwashing machine. It is however also conceivable to reverse this arrangement and provide the closing mouth on the appliance housing and the lock housing plus the closing arms on the door. Independently of this arrangement it is advantageous to dispose the lock housing plus the closing arms and the closing mouth at mutually corresponding positions on the door and the appliance housing that lie as precisely opposite one another as possible in the closed state of the door. This guarantees an easier engagement of the free arm portions of the closing arms into the closing mouth.

The deflectability of the free arm portions may be based at least partially on an inherent flexibility of the closing arms. For this purpose the closing arms may be formed from a flexible material. Alternatively or additionally the deflectability of the free arm portions may be based at least partially on a movable, for example pivotable, mounting of the closing arms in the lock housing. It is accordingly possible to configure the closing arms completely rigid and to mount the rigid closing arms pivotably on the lock housing. It is equally conceivable to equip the closing arms with a specific inherent flexibility and additionally mount them pivotably on the lock housing.

The free arm portions of the closing arms may carry roll-mounted rolling elements that guarantee a rolling contact of the free arm portions with the deflection surfaces. The rolling elements are disposed in particular on the free ends of the free arm portions. By means of the rolling elements the free arm portions may slide with less friction along the deflection surfaces. As an alternative to the rolling elements, the free ends of the free arm portions may have sliding surfaces that travel along the deflection surfaces during the engagement of the arm portions into the closing mouth. By replacing the sliding surfaces with rolling elements, the sliding friction between the closing arms and the deflection surfaces may be reduced. This then likewise reduces the expenditure of force for introducing and removing the closing arms into and/or from the closing mouth.

According to a first development of the door lock the free arm portions of the closing arms are preferably deflectable towards one another from their relative normal position. The deflection surfaces of the closing mouth accordingly run preferably in a funnel-like manner towards one another.

According to a first variant of this first development, the resetting spring arrangement comprises a compression spring, such as a helical compression spring. The compression spring in this first variant is disposed preferably in longitudinal direction of the closing arms between the respective ends of the closing arms and extends transversely of the closing arms. The closing arms in the relative normal position may be held for example at a normal spacing from one another. When during the closing operation of the door the closing arms engage into the closing mouth (independently of whether the closing mouth disposed on the door is moved relative to the closing arms disposed on the appliance housing or whether the closing arms disposed on the door are moved relative to the closing mouth disposed on the appliance housing), the free arm portions are pressed together from their spaced-apart normal position counter to the action of the compression spring by the deflection surfaces running in a funnel-like manner towards one another. The further the free arm portions engage into the closing mouth, the more the free arm portions are pressed together in accordance with the shape of the deflection surfaces. This enables the introduction of the closing arms into the closing mouth.

According to a second variant of this first development, the resetting spring arrangement comprises a tension spring such as a helical tension spring. As in the first variant, the closing arms may be held in the relative normal position for example at a normal spacing from one another. In a departure from the first variant, in the second variant the position of the mounting of the closing arms and the position of the spring in longitudinal direction of the closing arms may be transposed. Preferably in the second variant the tension spring is disposed on the respective other ends than the free ends of the closing arms and extends transversely of the closing arms. Thus, the tension spring may hold the closing arms in the normal position. When during the closing operation of the door the closing arms engage into the closing mouth, the free arm portions are pressed together from their spaced-apart normal position counter to the action of the tension spring by the deflection surfaces that run in a funnel-like manner towards one another. The further the free arm portions engage into the closing mouth, the more the free arm portions are pressed together in accordance with the shape of the deflection surfaces. This enables the introduction of the closing arms into the closing mouth.

In line with the first development, the deflection surfaces running in a funnel-like manner towards one another terminate preferably in an end region of the closing mouth. As in this case a force is no longer exerted on the free arm portions counter to the action of the compression spring (first variant) or the tension spring (second variant), the arm portions are deflected away from one another (in a second deflection direction) by the action of the compression spring and/or the tension spring and the free ends of the arm portions may be received by cavities formed in the end region of the closing mouth. A connection between the arm portions and the closing mouth is thereby formed, which is based at least partially on a frictional connection. For example, for releasing this frictional connection a force of between 50 and 150, for example between 80 and 120, and preferably of 100 Newtons, is required. Even if this force is exceeded, no damage to the door lock occurs, rather the frictional connection is released.

According to a reversal of the functional principle of the first development, according to a second development the resetting spring arrangement may comprise a tension spring, which is disposed at a position between the closing arms that corresponds to the compression spring according to the first variant of the first development. According to this development the free arm portions are deflectable away from one another as a first deflection direction. The deflection surfaces in the context of this second development are formed in a pyramid- or cone-like manner in the centre of the closing mouth and during the engagement process press the arm portions apart from one another counter to the action of the tension spring. According to this reverse functional principle the deflection surfaces extending in a cone-like manner away from one another terminate in the end region of the closing mouth, with the result that the free arm portions are pressed together in the end region of the closing mouth for example by the action of the tension spring. The free ends of the arm portions may be received by cavities formed in the end region and hence form a frictional connection with the end region.

In the normal position of the free arm portions the mutual spacing of the free arm portions of the closing arms may be determined by a connecting bridge arrangement that is applied to both closing arms. The connecting bridge arrangement may for example block the free arm portions in the normal position thereof to prevent a relative movement in the second relative deflection direction that is opposed to the first relative deflection direction. However, in the normal position the free arm portions may for example possess motional clearance relative to the lock housing in a direction of motion corresponding to the second relative deflection direction. For example, the blocking of the free arm portions by means of the connecting bridge arrangement may prevent the free arm portions from being deflected relative to one another in the second deflection direction. In this case, the free arm portions connected to one another by the connecting bridge arrangement may be moved simultaneously in the direction of motion. This motional clearance ensures that, even if the arm portions and the closing mouth do not lie ideally opposite one another, an engagement of the arm portions into the closing mouth is guaranteed.

The door lock may further comprise a control element configured for manual actuation, which is displaceable between a first position and a second position relative to the lock housing and which guarantees in its first position a facilitated relative deflection of the arm portions of the closing arms in the first relative deflection direction and in its second position an at least—compared to the first position of the control element—more difficult relative deflection of the arm portions in the first relative deflection direction. For this purpose, in the closed state of the door the control element may be displaceable from its first position into its second position and vice versa. The more difficult relative deflection of the arm portions in the first deflection direction may be achieved for example in that the length of the active lever arms of the free arm portions is reduced by the control element. The control element for this purpose may comprise a blocking element, which is disposed preferably between the closing arms. If the first deflection direction corresponds to a direction of the closing arms towards one another, the active lever arms of the free arm portions become shorter, the closer the blocking element is to the free ends of the arm portions.

The control element may for example in its first position enable a pivoting of the closing arms and in its second position prevent the closing arms from pivoting. In the event of blocking of the closing arms, a deflectability of the closing arms may exist due to inherent flexibility.

The door lock may further comprise a contacting element, which may be activated by one of the free arm portions of the closing arms in order thereby to actuate a switch disposed in the door lock. For example, the contacting element may comprise a contacting pin that may be moved by one of the free arm portions transversely of the direction of introduction of the arm portions into the closing mouth when the arm portions upon further engagement into the closing mouth are deflected partially back in the direction of their relative normal position. As a result of the transverse movement of the contacting pin, a microswitch for example disposed as a switch in the door lock may be actuated. The actuation of the microswitch into its new position may then be detected and on this basis the closed state of the door may be deduced.

The door lock may also comprise an opening unit that enables an automatic opening of the dishwashing machine once the washing operation has finished and the drying operation is initiated. For this purpose the opening unit may be configured to convert a rotary motion brought about by a drive unit, such as an electric motor, to a translatory motion, which acts upon the closing arms, in such a way as to bring about a deflection of the free arm portions relative to one another counter to the action of the resetting spring arrangement. For example, the opening unit may comprise a threaded rod, which extends transversely of the closing arms through the closing arms and is rotatable with the aid of the drive unit, such as the electric motor, wherein load transfer elements such as slide blocks, which are disposed in a rotationally fixed manner on the threaded rod, as a result of rotation of the threaded rod bring about a deflection of the free arm portions relative to one another counter to the action of the resetting spring arrangement. The threaded rod has for example a contradirectional righthand-/lefthand thread. It is for example conceivable that a control unit responsible for controlling the dishwashing machine or a control unit provided in the door lock (which may be connected for example to the control unit of the dishwashing machine) detects that the washing operation has finished and a drying operation is to be initiated and activates the drive unit accordingly. The drive unit then brings about a rotary motion of the threaded rod, which via the thread is movable relative to the closing arms. During rotation of the threaded rod the load transfer elements connected in a rotationally fixed manner to the threaded rod act upon the closing arms in such a way that the free arm portions are moved relative to one another counter to the action of the resetting spring arrangement. Thus, the free arm portions move preferably into a position, in which their connection to the cavities of the end portion of the closing mouth is released. Then the drive unit is for example stopped and the door may be opened with a reduced expenditure of force.

The drive unit may for example be controlled by the control unit in such a way that the free arm portions are moved (with the aid of the load transfer elements) into a position, in which they are pressed together to an extent that enables an at least almost entirely friction-free opening of the door lock. Alternatively the control unit may control the drive unit in such a way that the free arm portions are pressed together only partially and to such an extent that the expenditure of force for opening the door is reduced (for example by a few Newtons). The reduction of the expenditure of force may for example be selected by a user via an input unit of the dishwashing machine, wherein the control unit then brings about a corresponding rotation of the drive unit. In this way, as a kind of comfort access, an easier opening of the door may be achieved.

Furthermore, an opening element may be additionally provided, such as for example an opening pin or ejection pin that is capable of pressing the door in opening direction. The opening element may be held in a normal position counter to the spring action of a spring arrangement acting in the direction of extent of the closing arms and, upon release of the spring arrangement, as a result of the spring action may experience a movement in the direction of the direction of extent of the closing arms. It is accordingly conceivable for the opening element to be initially held in the normal position counter to the spring action of the spring arrangement. If for example the control unit then detects that the washing operation has finished, the control unit may then instruct the (previously described) pressing-together of the free arm portions. After this operation the free ends of the free arm portions are at least partially released from the cavities. If the control unit then instructs for example a release of the spring arrangement, the opening element is moved by the spring action in the direction of extent of the closing arms, which results in the door being slightly pressed open by the opening element. The drying operation may then be carried out more efficiently with the door open.

The invention further relates to a dishwashing machine having the presently described door lock. Given a situation of proper fitting of the door lock in the dishwashing machine, the free arm portions (16a, 16b) prior to engagement into the closing mouth (32) are oriented preferably in the direction of a rear side of the door (3) and in the direction of the closing mouth (32).

The invention is further described below with reference to preferred embodiments.

### BRIEF DESCRIPTION OF THE DRAWINGS

FIG. 1a is a diagrammatic representation of a side view of a door lock according to a first embodiment of the present invention in the fitted state.

FIG. 1b is a diagrammatic representation of a lateral plan view of the door lock according to the first embodiment according to FIG. 1a.

FIG. 2a is a diagrammatic representation of a plan view of the door lock according to the first embodiment in an open state.

FIG. 2b is a diagrammatic representation of a plan view of the door lock according to the first embodiment in a closed state.

FIG. 3 is a diagrammatic representation of a lateral plan view of a component of a door lock according to a second embodiment of the present invention.

FIG. 4a is a diagrammatic representation of a lateral plan view of a component of a door lock according to a third embodiment of the present invention.

FIG. 4b is a diagrammatic representation of a plan view of the component of the door lock according to the third embodiment according to FIG. 4a.

FIG. 5a is a diagrammatic representation of a lateral plan view of a component of a door lock according to a fourth embodiment of the present invention.

FIG. 5b is a diagrammatic representation of a lateral plan view of the component of the door lock according to the fourth embodiment according to FIG. 5a.

FIG. 6 is a diagrammatic representation of a lateral plan view of a door lock according to a fifth embodiment of the present invention.

FIG. 7a is a diagrammatic representation of a lateral plan view of a component of a door lock according to a sixth embodiment of the present invention.

FIG. 7b is a further diagrammatic representation of the component of the door lock according to the sixth embodiment of the present invention of FIG. 7a in a turned-over position.

FIG. 8a is a diagrammatic representation of a lateral plan view of a component of a door lock according to a seventh embodiment of the present invention.

FIG. 8b is a diagrammatic representation of a lateral plan view of the component of the door lock according to the seventh embodiment according to FIG. 8a.

FIG. 8c is a diagrammatic representation of a lateral plan view of the component of the door lock according to the seventh embodiment according to FIG. 8a with a drive unit.

FIG. 8d is a diagrammatic representation of a lateral plan view of the component of the door lock according to the seventh embodiment according to FIG. 8a.

FIG. 8e is a diagrammatic representation of a lateral plan view of the component of the door lock according to the seventh embodiment according to FIG. 8a in an open position.

### DETAILED DESCRIPTION OF THE PREFERRED EMBODIMENT

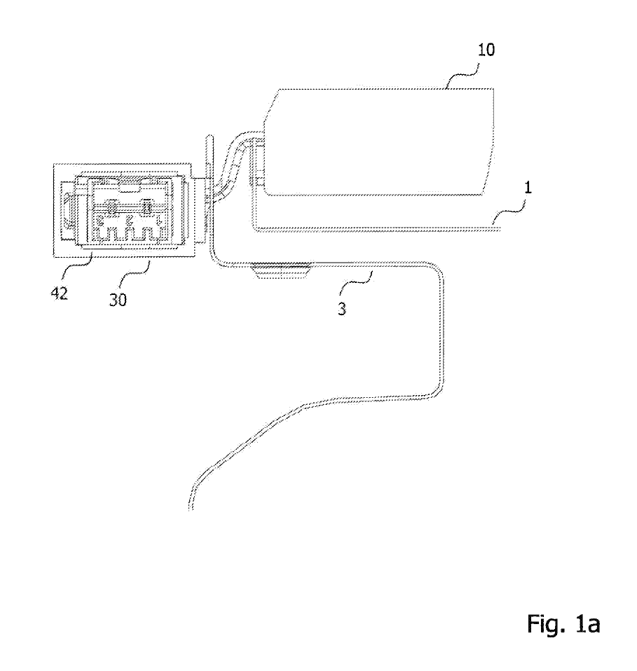

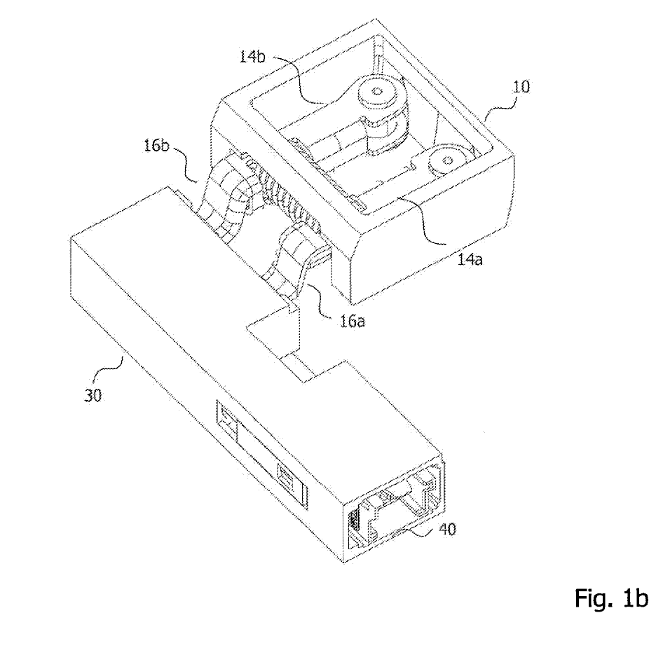

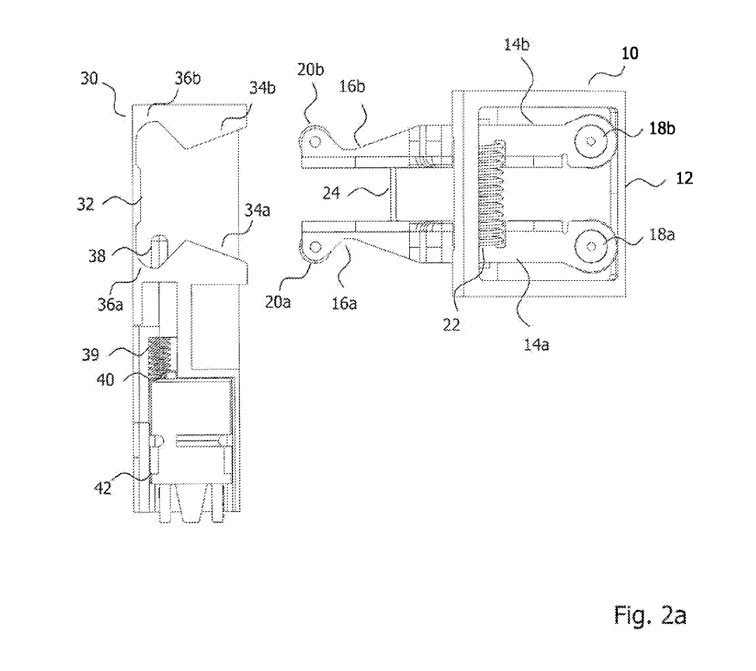

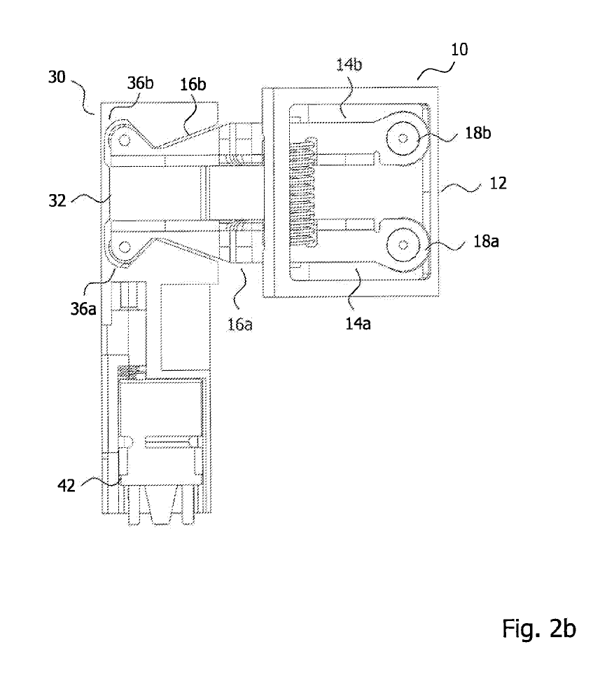

The preferred embodiments of the present invention are illustrated in FIGS. 1-8. FIGS. 1a, 1b, 2a and 2b show diagrammatic representations of various views of a door lock according to a first embodiment of the present invention. The door lock according to the first embodiment is shown in a closed state in FIGS. 1a, 1b and 2b and in an open state in FIG. 2a.

In FIG. 1a, it is diagrammatically indicated that a closing unit 10 is mounted as a first component of the door lock on an appliance housing 1 of a dishwashing machine. It is also indicated only diagrammatically in FIG. 1 that the closing unit 10 is mounted on the appliance housing 1 above the container for receiving the material that is to be cleaned. As a second component, a switchgear unit 30 of the door lock is mounted on a door 3 of the dishwashing machine, as is likewise diagrammatically indicated in FIG. 1a. In the closed state of the door lock shown in FIG. 1a the two components, the closing unit 10 and the switchgear unit 30, lie opposite one another and may therefore enter into a releasable connection with one another. The door lock is not limited to the previously described arrangement, in which the closing unit 10 is disposed in the appliance housing 1 and the switchgear unit 30 is disposed on the door 3. It is equally possible for the closing unit 10 to be disposed on the door 3 and the switchgear unit 30 to be disposed in the appliance housing 1.

FIG. 1b shows the door lock according to the first embodiment in a state, in which it is not fitted in the dishwashing machine but is closed.

FIGS. 2a and 2b show further details of the door lock according to the first embodiment of the present invention. The closing unit 10 of the door lock comprises a housing 12, to which two closing arms 14a, 14b are connected. The closing arms 14a, 14b are mounted in each case via a bearing 18a, 18b in the housing 12. Each of the closing arms 14a, 14b is rotatable about its associated bearing 18a, 18b. In each case free arm portions 16a, 16b of the closing arms 14a, 14b project from the housing 12. Disposed between the two closing arms 14a, 14b is a compression spring 22, which by means of its spring action presses the two closing arms 14a, 14b apart from one another. As is represented by way of example in FIGS. 2a and 2b, the compression spring 22 is fitted in between the two closing arms 14a, 14b. The door lock according to the first embodiment is however not limited thereto, i.e. the compression spring 22 may be disposed in some other way than by fitting in between the closing arms 14a, 14b. The normal mutual spacing of the two closing arms 14a, 14b is determined by means of a bridge arrangement 24 that is connected to the two closing arms 14a, 14b. As the bridge arrangement 24 is permanently connected to the two closing arms 14a, 14b, the closing arms 14a, 14b in their normal position are remote from one another by a normal spacing, which is determined by the width of the bridge arrangement 24 and corresponds substantially to this width.

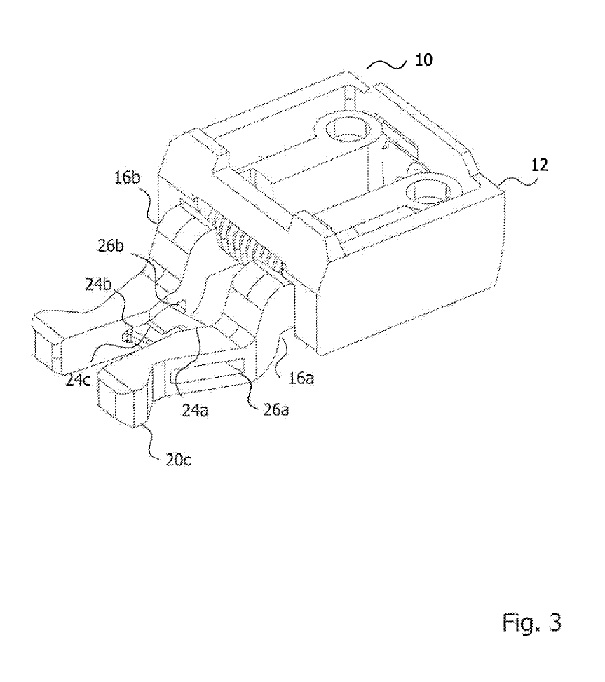

In FIGS. 2a and 2b the bridge arrangement 24 is only diagrammatically indicated. Details of the bridge arrangement may be seen in FIG. 3. FIG. 3 in fact shows a door lock according to a second embodiment of the present invention. The first and the second embodiment do not however differ in the configuration of the bridge arrangement 24. As may be seen in FIG. 3, the bridge arrangement 24 is of a two-part construction. A first part 24a of the bridge arrangement 24 is in this case permanently connected to the first closing arm 14a (more precisely, to the free arm portion 16a of the first closing arm 14a). The second part 24b on the other hand is permanently connected to the second closing arm 14b (more precisely, to the free arm portion 16b of the second closing arm 14b). The two bridge parts 24a, 24b are in mutual engagement. This engagement is achieved in that both bridge parts 24a, 24b extend at least almost parallel to one another between the closing arms 14a, 14b and transversely of their direction of extent have projections on their respective end. Such a projection 24c is shown in FIG. 3 for the bridge part 24a that is connected to the first closing arm 14a. However the bridge part 24b also has such a projection. The free arm portions 16a, 16b are pressed apart from one another by the action of the compression spring 22. The free arm portions 16a, 16b may however not be further remote from one another than is dictated by the width of the bridge arrangement 24. This is because the projection 24c of the first bridge part 24a engages in such a way into the second bridge part 24b that the projection 24c presses against a side of the second bridge part 24b counter to the action of the compression spring 22 and hence braces the free arm portion 16a against the second free arm portion 16b. In an identical manner the non-illustrated projection of the second bridge part 24b engages into the first bridge part 24a. As a result of the mutual engagement of the bridge parts 24a, 24b into one another, the free arm portions are quasi fastened to one another and cannot be pressed further apart from one another by the action of the compression spring 22 than their normal spacing.

The free arm portions 16a, 16b each have a recess 26a, 26b, into which the bridge parts 24a, 24b may engage when the arm portions 16a, 16b are pressed together counter to the action of the compression spring 22. More precisely, as the arm portions 16a, 16b are pressed together, the bridge part 24a connected to the first free arm portion 16a travels into the recess 26b formed in the second free arm portion 16b. Similarly, as the arm portions 16a, 16b are pressed together, the second bridge part 24b connected to the second free arm portion 16b travels into the recess 26a formed in the first free arm portion 16a. In FIG. 3 the recess 26a, 26b are shown as openings that fully penetrate the associated arm portions 16a, 16b. However none of the embodiments shown in the figures is limited thereto. It is equally possible not to configure the recesses 26a, 26b as complete openings that are open towards both sides of the corresponding arm portion but to provide an opening only towards the inner sides (the sides oriented counter to the action of the compression spring 22) of the respective arm portion, so that the openings of the recesses 26a, 26b lie opposite one another. The outer sides (the sides oriented in the direction of the action of the compression spring 22) may in this case be closed. This alternative configuration also enables an at least partial introduction of the bridge parts 24a, 24b into the opposite recess 26a, 26b.

The door lock according to the first embodiment will now be described again with reference to FIGS. 2a and 2b. According to the embodiment shown in FIG. 2a each of the closing arms 14a, 14b may be deflected inwards independently of the other closing arm 14a, 14b. As a result of the inward deflection the mutual spacing of the closing arms 14a, 14b is reduced.

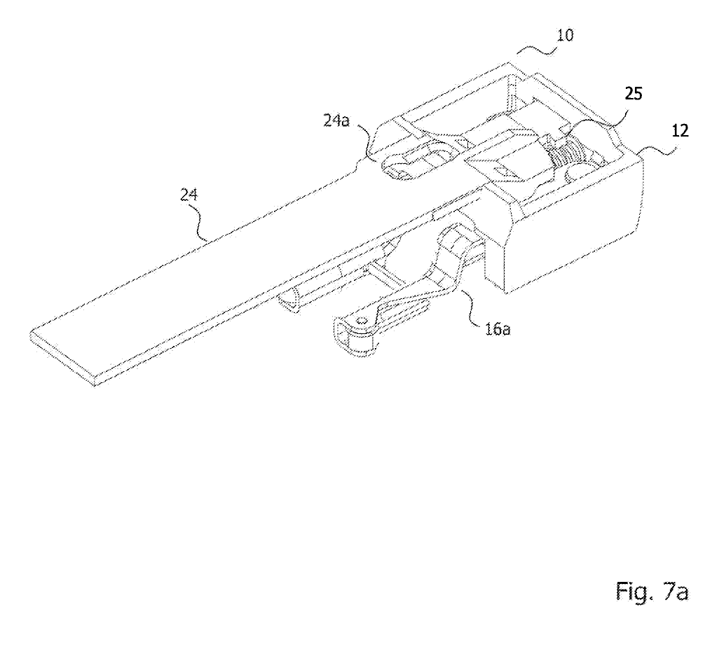

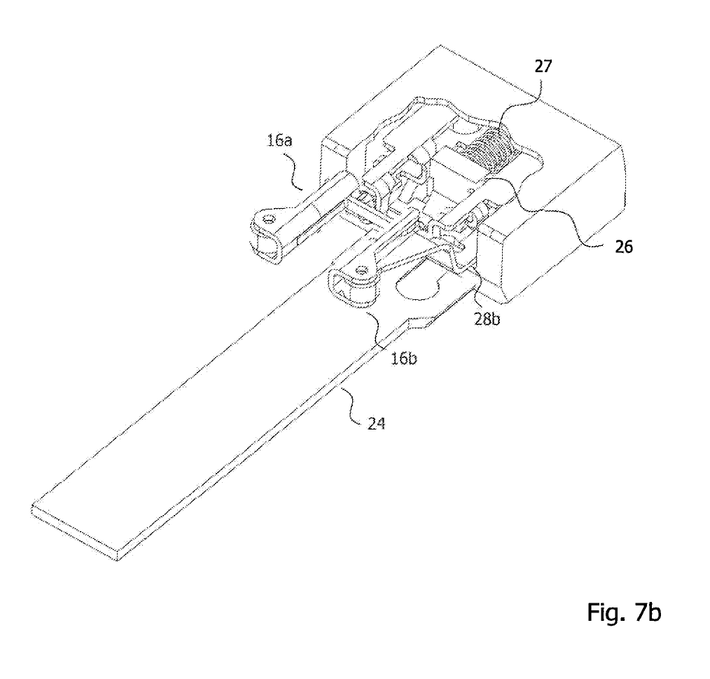

The outer sides of the closing arms 14a, 14b in their normal position do not rest directly against the inner wall of the housing 12. This is shown most clearly in FIGS. 7a and 7b but applies similarly to the first embodiment according to FIGS. 1a to 2b and the second embodiment according to FIG. 3. Between the inner wall of the housing 12 and the outer side of the second closing arm 14b there is a gap 28b (see FIG. 7b). A similarly designed gap (not shown) is situated in a corresponding manner between the first closing arm 14a and the opposite inner wall of the housing 12. Because of the gap at both sides the closing arms 14a, 14b connected by the bridge arrangement 24 may be moved jointly. This joint movement may be effected both in the direction of the gap 28b and in the direction of the non-illustrated gap, wherein both closing arms 14a, 14b maintain their constant normal mutual spacing. This minimal joint movement of the closing arms 14a, 14b may be referred to as a motional clearance in relation to the housing 12.

Finally, as may be seen in FIG. 2a, the two closing arms 14a, 14b each have a roller 20a, 20b on their free end (the end, at which they are not mounted rotatably about the bearing 18a, 18b).

As may be seen in FIGS. 2a and 2b, the switchgear unit 30 has a closing mouth 32 that is adapted to the free arm portions 16a, 16b of the closing arms 14a, 14b. The closing mouth 32 comprises two deflection surfaces 34a, 34b that are adapted to the free arm portions 16a, 16b. Situated in an end portion of the closing mouth are two cavities 36a, 36b that correspond to the shape of the free ends of the arm portions 16a, 16b in such a way that the free ends carrying the rollers 20a, 20b may be received in the cavities 36a, 36b.

When the door 3 is moved relative to the appliance housing 1 and closed, the free arm portions 16a, 16b engage into the closing mouth 32. During closing of the door 3 the switchgear unit 30 and the closing unit 10 move relative to one another towards one another. Close to the end of the closing operation the arm portions 16a, 16b engage into the closing mouth 32 and slide with their rollers 20a, 20b along the associated deflection surfaces 34a, 34b. As may be seen in FIG. 2a, the deflection surfaces run in a funnel-like manner towards one another and therefore narrow the opening of the closing mouth 32. In accordance with the narrowing the free arm portions 16a, 16b are increasingly pressed together counter to the action of the compression spring 22 until the point of maximum narrowing in the closing mouth 32 is reached. When the free arm portions 16a 16b during further engagement move beyond the corresponding point of maximum narrowing (and hence their maximum deflection relative to one another counter to the spring action), the closing mouth 32 widens in the end portion of the closing mouth 32. Since upon entry into the end portion a force is no longer exerted on the arm portions 16a, 16b by the deflection surfaces 34a, 34b, the free arm portions 16a, 16b are deflected in each case in the direction of the spring action back towards their normal position. Depending on the width and shape of the end portion, the free arm portions 16a, 16b of the closing arms 14a, 14b may in this case return to their normal position, but may alternatively move into an intermediate position, in which their mutual spacing is smaller than the normal spacing.

During closing of the door 3 the arm portions 16a, 16b engage further into the end portion until the end position is reached. In this end position the free ends of the arm portions 16a, 16b that carry the rollers 20a, 20b are situated in the cavities 36a, 36b and the closing unit 10 and the switchgear unit 30 enter into a frictional connection with one another. The door 3 may be opened again counter to the force exerted by this frictional connection if the externally exerted force exceeds the opposing force produced by the frictional connection. The first embodiment is adapted in such a way that the force required for opening is ca. 50 N.

When the door is opened, the rollers 20a, 20b of the arm portions 16a, 16b slide along the rising inner surfaces of the cavities 36a, 36b. The arm portions 16a, 16b are therefore pressed together until they reach the point of maximum narrowing. When the arm portions 16a, 16b are moved further relative to the closing mouth 32 counter to the direction of engagement when closing the door, the rollers 20a, 20b slide backwards along the deflection surfaces 34a, 34b, and the arm portions 16a, 16b are pressed apart again by the action of the compression spring 22. After the complete release of the switchgear unit 30 from the closing unit 10, the arm portions 16a, 16b return to their normal position.

FIG. 2b shows the closed (end) state with fully engaged arm portions 16a, 16b. In this representation according to FIG. 2b the free arm portions 16a, 16b have for example returned to their normal position, in which they are held by means of the bridge arrangement 24. This is however to be understood as merely by way of example and the end portion, into which the arm portions 16a, 16b have engaged, may alternatively be formed with a smaller width than the width of the bridge arrangement 24, so that the arm portions 16a, 16b are held in the closing mouth 32 with a smaller mutual spacing than the normal spacing. In the state shown in FIG. 2b the switchgear unit 30 and the closing unit 10 are connected releasably to one another in that they enter into an at least partial frictional connection with one another.

As is evident from FIG. 2a, the switchgear unit 30 further comprises a contacting element, which in FIG. 2a is configured by way of example as contacting pin 38. The switchgear unit 30 further comprises a switch configured by way of example as microswitch 40, which acts upon a connection configured by way of example as Rast 2.5 connector.

As is evident from FIGS. 2a and 2b, the first arm portion 16a presses the contacting pin 38 downwards transversely of the direction of engagement of the arm portions 16a, 16b. The contacting pin 38 therefore activates the microswitch 40. As a result of the activation of the microswitch 40 it is detected that the door 3 of the dishwashing machine has been fully closed. As a result of the activation of the microswitch 40 the electric circuit in the dishwashing machine is then closed and the washing operation may be carried out. This is not possible if the door is not fully closed. It is alternatively conceivable that the microswitch 40 is activated in the open state of the door and the deactivation of the microswitch 40 that is triggered by displacement of the contacting pin 38 is detected and indicates that the door 3 has been closed.

FIG. 3 shows the closing unit 10 of the door lock according to a second embodiment of the present invention. In this second embodiment the switchgear unit (not shown) corresponds to the switchgear unit 30 of the first embodiment shown in FIGS. 1a to 2b. The closing unit 10 according to the second embodiment differs from the closing unit 10 of the first embodiment only in that, not rollers 20a, 20b, but sliding surfaces 20c are formed on the free ends of the arm portions 16a, 16b. As a result, as the arm portions 16a, 16b engage into the closing mouth 32, the sliding friction between the arm portions 16a, 16b and the deflection surfaces 34a, 34b and hence the expenditure of force required for the introduction process is increased (compared to the first embodiment). Accordingly, in the closed position also the sliding friction in the second embodiment is increased, with the result that a higher force has to be expended to release the connection between the switchgear unit 30 and the closing unit 10.

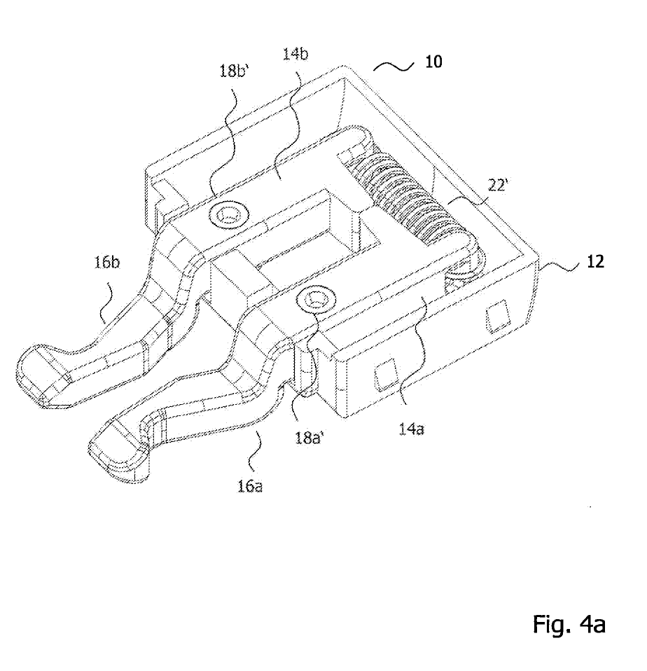

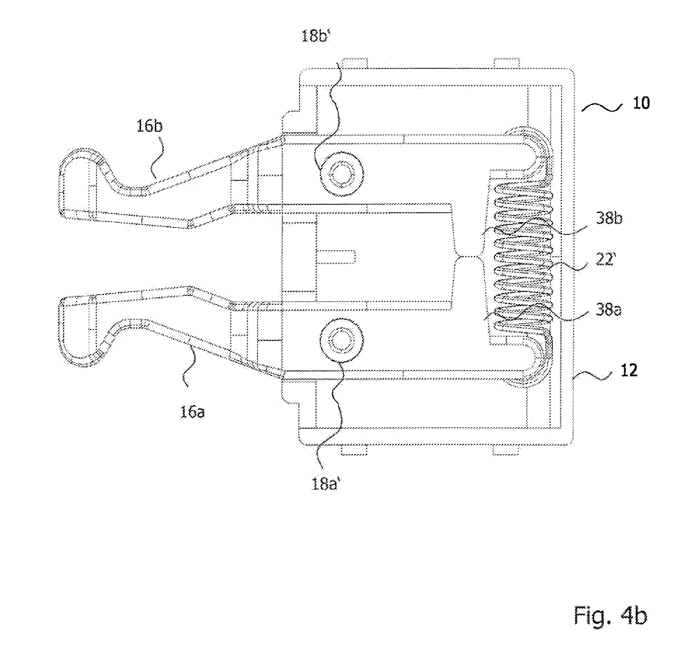

According to a third embodiment the closing unit 10 of the door lock that is shown in FIG. 4a differs from the closing unit 10 of the second embodiment in that instead of the compression spring 22 a tension spring 22′ is disposed between the closing arms 14a, 14b and the bearings 18a′, 18b′ of the closing arms 14a, 14b are disposed at other points in longitudinal direction of the closing arms 14a, 14b than the bearings 18a, 18b. More precisely, the bearings 18a′, 18b′ are no longer disposed on the ends of the closing arms 14a, 14b but are situated in longitudinal direction of the closing arms 14a, 14b approximately where in the second embodiment the compression spring 22 was disposed. Naturally the positions of the bearings 18a′, 18b′ in longitudinal direction of the closing arms 14a, 14b is to be understood as merely by way of example, i.e. the bearings 18a′, 18b′ may alternatively be situated at other suitable positions. The tension spring 22′ is situated between the ends of the closing arms 14a, 14b that are disposed in the housing 12. Furthermore, as is evident from FIG. 4b, the closing unit 10 according to the third embodiment has 2 blocking elements configured as blocking fingers 38a, 38b, which are supported against one another. Consequently the closing arms 14a, 14b are also supported against one another.

The closing unit 10 according to FIGS. 4a and 4b may be used with the switchgear unit 30 of FIGS. 2a and 2b. When the door 3 is then moved relative to the appliance housing 1 and closed, the free arm portions 16a, 16b of the closing unit 10 of FIGS. 4a and 4b engage into the closing mouth 32 of the switchgear unit 30 of FIGS. 2a and 2b. During closing of the door 3 the switchgear unit 30 and the closing unit 10 move relative to one another towards one another. Close to the end of the closing operation the arm portions 16a, 16b engage into the closing mouth 32 and slide with their free ends of the arm portions 16a, 16b along the associated deflection surfaces 34a, 34b. Since, as is evident from FIG. 2a, the deflection surfaces 34a, 34b run in a funnel-like manner towards one another and hence narrow the opening of the closing mouth 32, the free arm portions 16a, 16b are in accordance with the narrowing increasingly pressed together counter to the action of the tension spring 22′ until the point of maximum narrowing in the closing mouth 32 is reached. When the free arm portions 16a, 16b upon further engagement move beyond the corresponding point of maximum narrowing, the closing mouth 32 widens in the end portion of the closing mouth 32. Since upon entry into the end portion a force is no longer exerted on the arm portions 16a, 16b by the deflection surfaces 34a, 34b, the tensile force of the tension spring 22′ results in the free arm portions 16a, 16b being deflected in each case back in the direction of their normal position. Depending on the width and shape of the end portion, the free arm portions 16a, 16b of the closing arms 14a, 14b may in this case return to their normal position but may alternatively move into an intermediate position, in which their mutual spacing is smaller than the normal spacing. Thus, the free arm portions 16a, 16b are each deflected back towards their normal position counter to the direction of the spring action.

During further closing of the door 3 the arm portions 16a, 16b engage further into the end portion until the end position is reached. In this end position the free ends of the arm portions 16a, 16b are situated in the cavities 36a, 36b and the closing unit 10 and the switchgear unit 30 enter into a frictional connection with one another. The door 3 may be re-opened counter to the force exerted by this frictional connection if the externally exerted force exceeds the opposing force produced by the frictional connection. The third embodiment also is adapted in such a way that the force required for opening is ca. 50 Newtons.

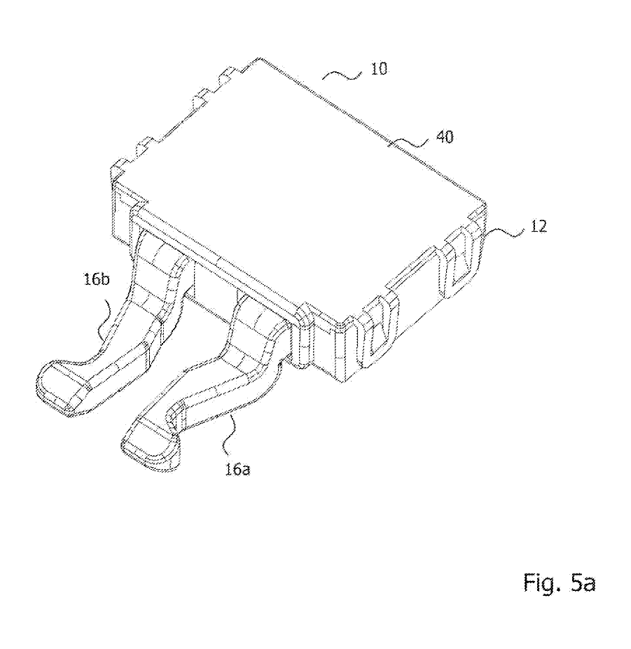

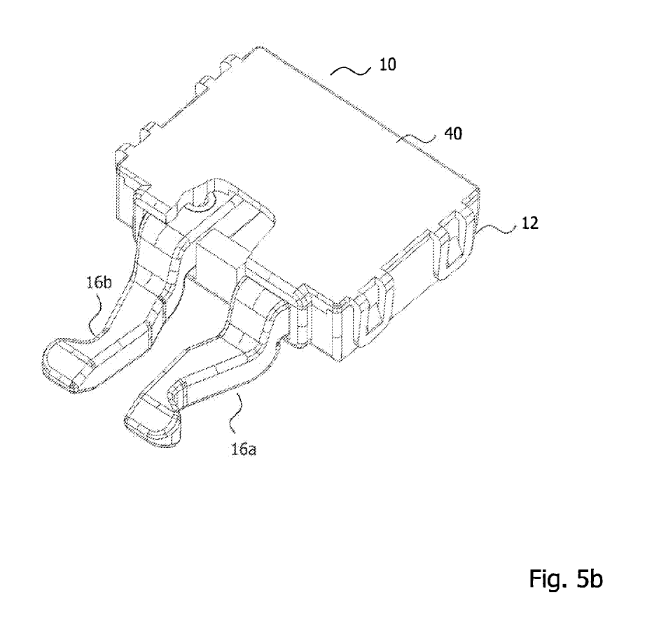

FIGS. 5a and 5b show the closing unit 10 according to a fourth embodiment. This fourth embodiment corresponds to the third embodiment of FIGS. 4a and 4b and moreover comprises a cover 40. As may be seen in FIG. 5b, in each case a projection associated with the bearings 18a′, 18b′ and formed on the cover 10 projects into the bearing points. This results in an increased and improved fixing of the bearing points.

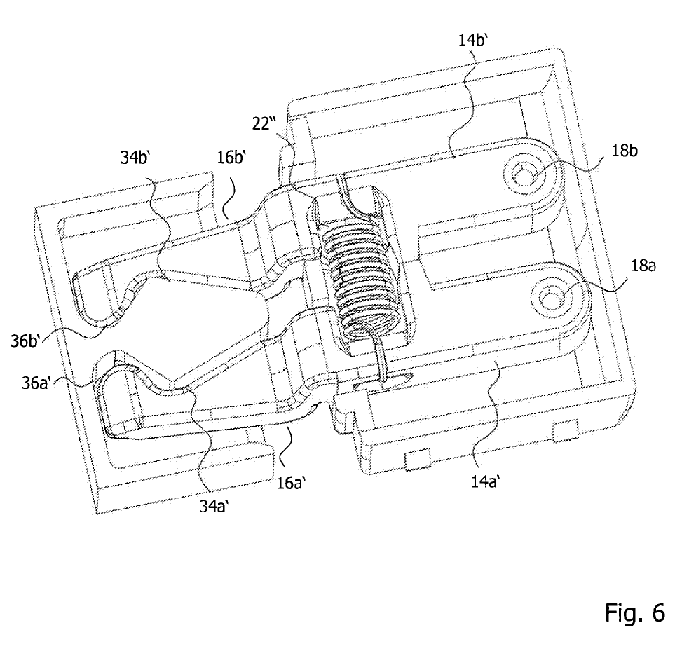

FIG. 6 shows a door lock according to a fifth embodiment. In the fifth embodiment the functional principle described with reference to FIGS. 1 to 5b is reversed. The functional principle outlined with reference to the previously described embodiments is based on the fact that initially the free arm portions 16a, 16b of the closing arms 14a, 14b are held mutually spaced apart in a relative normal position by the transversely effective action of the spring 22, 22′. During engagement of the free arm portions 16a, 16b into the closing mouth 32 the free arm portions 16a, 16b are pressed together and finally pressed apart again in the direction of the normal position. According to the fifth embodiment of FIG. 6 this functional principle is reversed in that the free arm portions 16a′, 16b′ are held in a normal position by means of a tension spring 22″. In the normal position shown by way of example in FIG. 6, the free arm portions 16a′, 16b′ are spaced apart from another. It is however also conceivable that the free arm portions 16a, 16b (in the normal position) are fully pressed together. During engagement into the closing mouth 32 the free arm portions 16a′, 16b′ interact in such a way with deflection surfaces 34a′, 34b′ disposed in a cone-like manner that the free arm portions 16a′, 16b′ are pressed apart from one another counter to the action of the tension spring 22″. After further engagement into the closing mouth 32 the free arm portions 16a′, 16b′ are pressed together again by the action of the tension spring 22″ and engage into cavities 36a′, 36b′ in order to form a keyed connection. As is evident from FIG. 6, the deflection surfaces 34a′, 34b′ together with the cavities 36a′, 36b′ form a mushroom-like formation. The engagements of the free ends of the arm portions 16a′, 16b′ are directed inwards and adapted to the cavities 36a′, 36b′.

According to a sixth embodiment the closing unit 10 of the door lock shown in FIGS. 7a and 7b differs from the closing unit 10 of the first embodiment in that there is disposed between the closing arms 14a, 14b a blocking element 26, which may be displaced by means of a manual actuation element 24. The blocking element 26 in its first position shown in FIG. 7b is positioned in such a way that it extensively enables the relative deflection of the arm portions 16a, 16b of the closing arms 14a, 14b, i.e. the free arm portions may be deflected extensively uninfluenced by the blocking element 26. The blocking element 26 is held in the first position counter to the action of a second compression spring 27 acting in the direction of the direction of extent of the closing arms 14a, 14b in that a lug 25 of the manual actuation element 24 is supported against the outer wall of the housing 12 counter to the action of the second compression spring 27. By actuating the manual actuation element 24 in such a way that the lug 25 is detached from the outer wall of the housing 12, the manual actuation element 24 and the blocking element 26 connected thereto are pressed by the action of the second compression spring 27 in the direction of the direction of engagement of the free arm portions 16a, 16b and the blocking element therefore moves into a second position. The movement of the manual actuation element is guided with the aid of a guide 24a.

In the second position the relative deflectability of the arm portions 16a, 16b is almost blocked. This is achieved by the fact that the blocking element 26 is situated closer to the free ends of the arm portions 16a, 16b and hence shortens the active lever arm of the arm portions 16a, 16b. Given completely rigid closing arms 14a, 14b, a movement of the arm portions 16a, 16b may then be completely prevented. If the closing arms 14a, 14b are not completely rigid but flexible, a slight deflection of the arm portions 16a, 16b may occur due to the inherent flexibility.

When the blocking element is in its second position (blocking position), both the engaging of the arm portions 16a, 16b of the closing arms 14a, 14b into the closing mouth 32 and the release thereof from the closing mouth 32 are made more difficult.

With the aid of the blocking element 26 the following functionality may be achieved. Firstly, in the open state of the door 3 the blocking element 26 is in its first position, in which the deflection of the free arm portions 16a, 16b of the closing arms is facilitated. In this position, during closing of the door 3 the arm portions 16a, 16b of the closing arms 14a, 14b in the course of engaging into the closing mouth 32 are first pressed together and finally pressed apart from one another again in the direction of the action of the compression spring 22 in order to enter into the connection with the switchgear unit 30. After closing of the door 3 the manual actuation element 24 projects out from the door 3 and is freely accessible from outside by a user and may be actuated by the user. By actuating the manual actuation element 24 the blocking element 26 is displaced by the action of the second compression spring 27 in the direction of the free ends of the arm portions 16a, 16b and hence (by shortening the active lever arm of the freely deflectable arm portions 16a, 16b) blocks the movement of the arm portions 16a, 16b towards one another. As a result, the release of the arm portions from the cavities 36a, 36b and hence opening of the door 3 are made more difficult. The third embodiment is adapted in such a way that a force of ca. 100 N is now required for opening the door 3 in the activated state of the blocking element 26 (i.e. the blocking element is situated in its second position, the blocking position). Such a force may namely be expended usually by an adult, but not by a child. The increased expenditure of force is based on the fact that the deflectability of the free arm portions in this state is based almost exclusively (if provided) on the inherent flexibility of the closing arms 14a, 14b. The increased expenditure of force prevents a child from accessing the washing compartment during a washing operation. However, an adult also senses that a higher expenditure of force is required and may deduce from this that the blocking element 26 is in its blocking state. To release this blocking the adult may simply move the manual actuation element 24 counter to the action of the second spring 27 and hence release the free arm portions 16a, 16b.

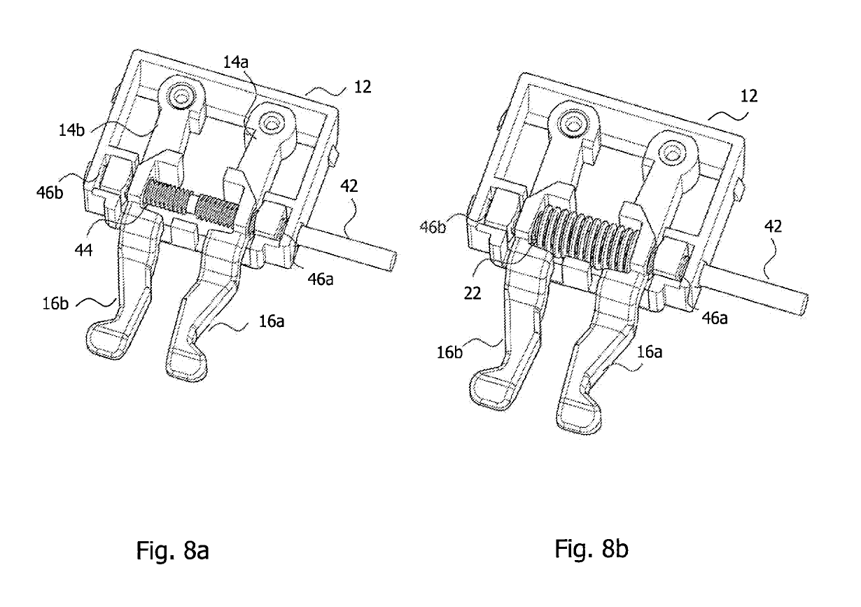

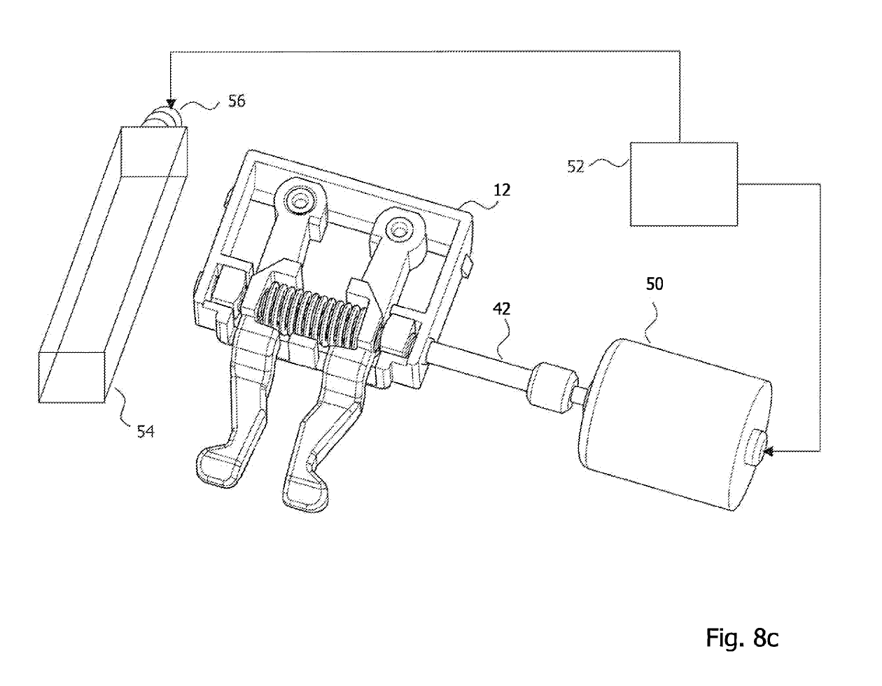

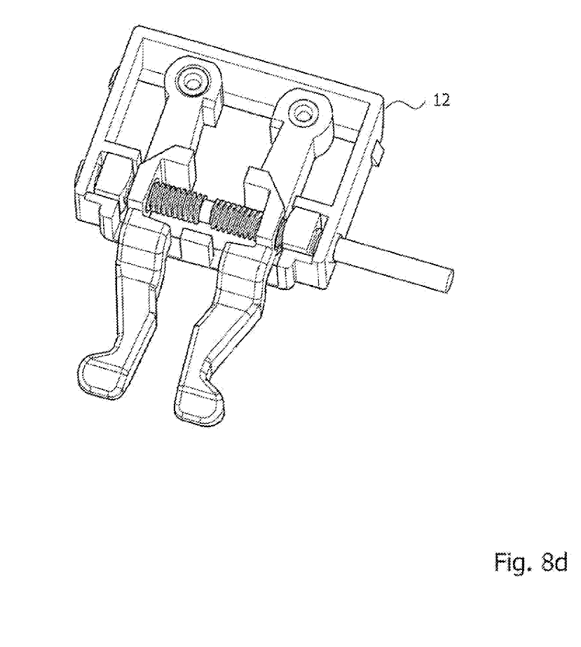

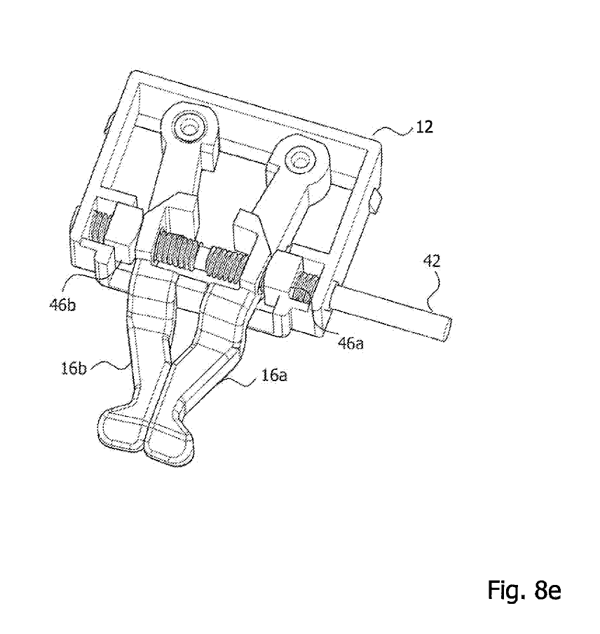

FIGS. 8a to 8e show a closing unit 10 of the door lock according to a seventh embodiment. In this seventh embodiment a threaded rod 42 having a contradirectional righthand-/lefthand thread 44 is inserted through the closing arms 14a, 14b transversely of the longitudinal direction of the closing arms 14a, 14b. As may be seen in FIG. 8c, the threaded rod 42 is connected to a drive unit configured for example as electric motor 50 for driving the threaded rod 42. Two slide blocks 46a, 46b disposed in a rotationally fixed manner on the threaded rod 42 are moreover situated in the housing 12. In the case of the use of a compression spring 22 the slide blocks 46a, 46b are disposed outside of the outer surfaces of the closing arms 14a, 14b. The compression spring 22 surrounds the thread 44 of the threaded rod 42. A control unit 52 is moreover diagrammatically indicated in FIG. 8c. The control unit 52 may be for example a control unit that is responsible for controlling the dishwashing machine. Alternatively the control unit 52 may be provided in the door lock or be connected thereto and receive instructions from the control unit of the dishwashing machine. The control unit 52 is connected to the electric motor 50 in such a way that it may communicate instructions to the electric motor 50. These instructions may include the duration of rotation of the electric motor 50, the speed of rotation, the number of rotations as well as the start point and end point of rotation and similar parameters. Further indicated in FIG. 8c is a compression spring 56, which in turn is connected to an ejection pin 54. The spring 56 in its normal position is preloaded counter to its spring action acting in the direction of the direction of extent of the closing arms 14a, 14b.

If the control unit 52 then detects that the washing operation has finished and the drying operation is to be initiated, the control unit 52 activates the electric motor 50, which then brings about a rotation of the threaded rod 42. As a result of the rotation of the threaded rod 42 the slide blocks 46a, 46b disposed in a rotationally fixed manner on the threaded rod 42 are not only co-rotated with the threaded rod 42 but are also moved towards the compression spring 22. As a result of the movement of the slide blocks 46a, 46b the closing arms 14a, 14b are pressed together counter to the action of the compression spring 22 until the free arm portions 16a, 16b are situated in an end position. This end position is represented by way of example in FIG. 8e. As is evident from FIG. 8e, in the end position the free arm portions 16a, 16b are fully pressed together at their free ends. Once the end position has been reached, the electric motor 50 is switched off by the control unit. As is evident from FIG. 8e in combination with FIG. 2b, in the end position the free ends of the free arm portions 16a, 16b are no longer situated in the cavities 36a, 36b but have moved inwards transversely of the direction of extent of the closing arms 14a, 14b, removed themselves from the cavities and are therefore no longer form a frictional connection with the cavities 36a, 36b. Opening of the door 3 is therefore possible with a minimal expenditure of force.

In order to guarantee an automatic opening of the door, the ejection pin 54 may further be provided, which may slightly press the door in the direction of extent of the closing arms and namely in the direction of opening of the door. The ejection pin 54 prior to conclusion of the washing operation is situated in a normal position, in which the compression spring 56 is preloaded. If the control unit 52 instructs the release of the spring 56 (because for example the washing operation has finished and the free arm portions 16a, 16b have also been sufficiently pressed together), the release of the spring 56 brings about a movement of the ejection pin 54 in the direction of extent of the closing arms 14a, 14b. As a result of this movement and the associated pressing of the ejection pin 54 against the door, the door is at least slightly pressed open. Consequently, at the start of the drying operation the door may be opened automatically, albeit only minimally, and the drying operation may be carried out more efficiently. Instead of the free arm portions 16a, 16b being pressed fully together, a comfort opening function of the dishwashing machine may also be achieved by the control unit 52 instructing only a lower rotation of the electric motor 50. The lower rotation of the electric motor 50 results in the free arm portions 16a, 16b being pressed together to a lesser extent. In this position, during opening of the door there is still a slight contact of the free arm portions 16a, 16b with the inner surfaces of the closing mouth 32. However, compared to the normal position of the closing arms 14a, 14b the friction is markedly reduced, thereby enabling an easier opening of the door with a reduced expenditure of force.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A door lock for a dishwashing machine comprising:
a lock housing;
a pair of closing arms, which are held in and project from the lock housing and of which the free arm portions projecting from the lock housing are deflectable relative to one another from a relative normal position in a relative first deflection direction counter to the action of a resetting spring arrangement; and
a closing mouth, into which the free arm portions of the closing arms engage during closing of the door of the dishwashing machine, wherein disposed on the closing mouth are deflection surfaces, which the free arm portions encounter during engagement into the closing mouth and which bring about a relative deflection of the free arm portions counter to the resetting action of the resetting spring arrangement, wherein the free arm portions during further engagement is move past the deflection surfaces and in so doing experience an at least partial resetting in the direction of their relative normal position.

2. The door lock according to claim 1 wherein the deflectability of the free arm portions is based at least partially on an inherent flexibility of the closing arms.

3. The door lock according to claim 1 wherein the deflectability of the free arm portions is based at least partially on a movable mounting of the closing arms in the lock housing.

4. The door lock according to claim 1 wherein the free arm portions of the closing arms carry roll-mounted rolling elements that guarantee a rolling contact of the free arm portions with the deflection surfaces.

5. The door lock according to claim 1 wherein the free arm portions of the closing arms are deflectable from their relative normal position towards one another and the deflection surfaces of the closing mouth run in a funnel-like manner towards one another.

6. The door lock according to claim 5 wherein the resetting spring arrangement comprises a helical compression spring or a helical tension spring.

7. The door lock according to claim 1 wherein the free arm portions of the closing arms are deflectable from their relative normal position away from one another and the deflection surfaces of the closing mouth run in a cone-like or pyramid-like manner away from one another.

8. The door lock according to claim 7 wherein the resetting spring arrangement comprises a helical tension spring.

9. The door lock according to claim 1 wherein in the normal position the mutual spacing of the free arm portions of the closing arms is determined by a connecting bridge arrangement, which is applied to on the two closing arms and which blocks the free arm portions in the normal position thereof to prevent a relative movement in a second relative deflection direction opposed to the first relative deflection direction.

10. The door lock according to claim 9 wherein in the normal position the free arm portions in a direction corresponding to the second relative deflection direction possess motional clearance relative to the lock housing.

11. The door lock according to claim 1 further comprising a control element configured for manual actuation, which is displaceable between a first position and a second position relative to the lock housing and which guarantees in its first position a facilitated relative deflection of the arm portions of the closing arms in the first relative deflection direction and in its second position a relative deflection of the arm portions in the first relative deflection direction that is at least more difficult compared to the first position of the control element.

12. The door lock according to claim 11 wherein in the closed state of the door the control element is displaceable from its first position into its second position and vice versa.

13. The door lock according to claim 11 wherein the control element in its first position enables a pivoting of the closing arms and in its second position prevents the closing arms from pivoting.

14. The door lock according to claim 1 further comprising a contacting element, which may be activated by one of the free arm portions of the closing arms in order thereby to actuate a switch disposed in the door lock.

15. The door lock according to claim 1 further comprising an opening unit, which is configured to convert a rotary motion, which is brought about by a drive unit to a translatory motion, which acts upon the closing arms, in a way that brings about a deflection of the free arm portions relative to one another counter to the action of the resetting spring arrangement.

16. The door lock according to claim 15 wherein the opening unit comprises a threaded rod, which extends transversely of the closing arms through the closing arms and is rotatable with the aid of the drive unit, wherein load transfer elements, which are disposed in a rotationally fixed manner on the threaded rod, as a result of rotation of the threaded rod bring about a deflection of the free arm portions relative to one another counter to the action of the resetting spring arrangement.

17. The door lock according to claim 15 wherein the opening unit comprises an opening element, which is held in a normal position counter to the spring action of a spring arrangement acting in the direction of extent of the closing arms and, upon release of the spring arrangement, by means of the spring action experiences a movement in the direction of the direction of extent of the closing arms.

18. A dishwashing machine having a door lock according to claim 1.

19. The dishwashing machine according to claim 18 wherein, given a situation of proper fitting of the door lock in the dishwashing machine, the free arm portions prior to engagement into the closing mouth are oriented in the direction of a rear side of the door and in the direction of the closing mouth.
